(19) United States
(12) Patent Application Publication
(10) Pub. No.: US 2011/0048022 A1
(43) Pub. Date: Mar. 3, 2011

(54) SYSTEM AND METHOD FOR COMBUSTION DYNAMICS CONTROL OF GAS TURBINE

(75) Inventors: Kapil Kumar Singh, Rexford, NY (US); Fei Han, Clifton Park, NY (US); Shiva Srinivasan, Greer, SC (US); Kwanwoo Kim, Greer, SC (US); Preetham Balasubramanyam, Schenectady, NY (US); Qingguo Zhang, Schenectady, NY (US)

(73) Assignee: GENERAL ELECTRIC COMPANY, SCHENECTADY, NY (US)

(21) Appl. No.: 12/550,354

(22) Filed: Aug. 29, 2009

(51) Int. Cl. F02C 7/22

(52) U.S. Cl. 60/742

(57) ABSTRACT

A combustor minimizes combustion emissions at a lower level of combustion dynamics during combustor even fuel-split conditions by varying the fuel impedance through geometrical changes or inert addition in various nozzle groups than that achievable during combustor even fuel-split conditions with a multi-fuel nozzle combustor using a nozzle fuel impedance that is common to all nozzles while emitting substantially the same level of combustion emissions.

### BACKGROUND

The invention relates generally to gas turbine combustors, and more specifically to a system and method for controlling gas turbine combustion dynamics by varying fuel nozzle impedance among various nozzle groups.

Each can of a multi-can gas turbine combustion system typically includes 2-3 or more different fuel supply nozzle groups. These fuel supply nozzles in different groups are generally identical in geometry with differences relating only to the amount of fuel flow. The relative amount of fuel-flow to different nozzle groups is referred to as fuel split, which is one of the primary tools to control combustion dynamics. However, the best conditions for achieving lowest dynamics usually do not correspond to operating conditions suitable for minimum emissions and vice-versa.

The unsteady flame inside a combustor can, when coupled with the natural modes of the combustor establishes a feedback cycle and can lead to high amplitude pressure pulsations with potential damage to the hardware. These problems are more pronounced with modern lean premixed combustion systems that are used to generate lower emissions and have been addressed in various manners including modification of generation mechanisms, changes to combustor geometry, and active and passive control.

Since the interaction of various flame groups with each other in a multi-nozzle gas turbine combustion system can be a critical factor in causing/controlling the combustion dynamics of the combustor, it would be both advantageous and beneficial to provide a system and method for operating a gas turbine at even fuel-splits in a manner that achieves minimization of emissions while simultaneously lowering the combustion dynamics amplitude.

### BRIEF DESCRIPTION

Briefly, in accordance with one embodiment, a combustor comprises a plurality of fuel nozzles, wherein at least one nozzle receives fuel from a first fuel line, and further wherein at least one different nozzle receives fuel from a second fuel line, each fuel line having a corresponding impedance such that the first fuel line impedance is fixedly or variably different from the second fuel line impedance. The impedance of the fuel lines is governed by the geometrical dimensions of nozzles and the fuel flow rate. The division of total fuel to various nozzles is referred to as the fuel split. When the amount of fuel per nozzle distributed among various nozzle groups is equal, the condition is referred to as even fuel-spilt.

According to another embodiment, a combustor comprises a plurality of fuel nozzles, wherein at least one nozzle receives fuel from a first fuel line, and further wherein at least one different nozzle receives fuel from a second fuel line, each nozzle comprising a fuel line impedance that is fixedly or variably different from at least one other nozzle fuel line impedance.

According to yet another embodiment, a combustor is configured to minimize combustion emissions at a lower level of combustion dynamics during combustor even fuel-split conditions by varying the fuel impedance through geometrical changes or inert addition in various nozzle groups than that achievable during combustor even fuel-split conditions with a multi-fuel nozzle combustor using nozzles with identical or similar impedance and high dynamics preventing attainment of the same low level of combustion emissions.

### DRAWINGS

These and other features, aspects, and advantages of the present invention will become better understood when the following detailed description is read with reference to the accompanying drawings in which like characters represent like parts throughout the drawings, wherein:

FIG. 1 illustrates a combustor can with a plurality of nozzle groups in which pre and post orifice sizes for one nozzle group are different from pre and post orifice sizes for another nozzle group according to one embodiment of the invention;

FIG. 2 illustrates a gas turbine that employs the combustor can depicted in FIG. 1; and

FIG. 3 is a more detailed view of the combustor depicted in FIG. 2.

While the above-identified drawing figures set forth alternative embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION

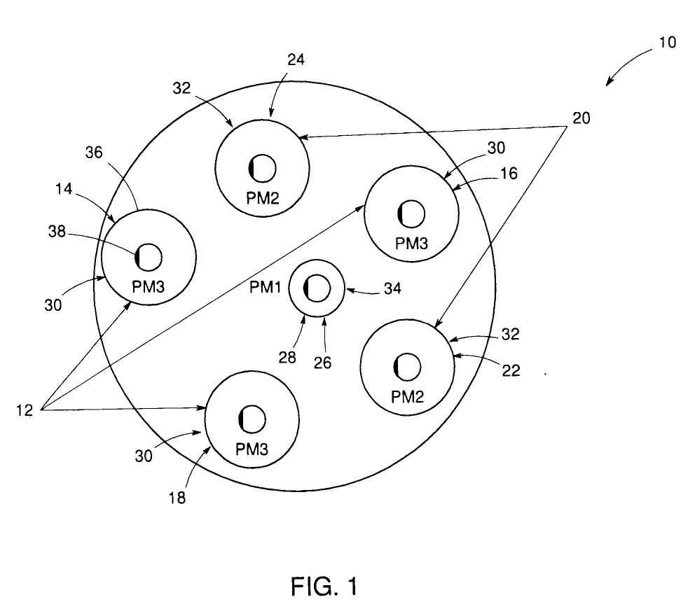

FIG. 1 illustrates a combustor can 10 with a plurality of nozzle groups 12, 20, 26 in which pre and post orifice sizes for one nozzle group are different from pre and post orifice sizes for another nozzle group according to one embodiment of the invention. Each combustor can in a multi-can combustion system typically has 2-3 different fuel supply nozzle groups such as depicted in FIG. 1. Typically, these nozzles are identical which is problematic with respect to combustion dynamics during combustor even fuel split (equal fuel/air mixture in nozzles of different groups) conditions. The unsteady flame/s inside a combustor may couple with the natural modes of the combustor establishing a feedback cycle which leads to high amplitude pressure pulsations with potential to damage the hardware. This problem is more pronounced with modern lean premixed combustion systems, which are used to achieve lower emissions because these systems are more susceptible to equivalence ratio and acoustic/flow perturbations. Further, in multi-nozzle systems the problem becomes more severe when all flames from different nozzles have identical or similar characteristics, which is the case at even split. However, often the gas turbines achieve the lowest emissions at the even splits but cannot be operated at this condition due to high combustion dynamics.

The interaction of various flame groups with one another in a multi-nozzle combustor system is known to be a critical factor in causing/controlling the combustion dynamics of the combustor. Therefore, fuel splitting has been successfully employed to control combustion dynamics. However, at even fuel split the characteristics of the various flame groups are very similar/identical, which inhibits operation to bring the emissions further lower. Since the fuel line impedance characterizes the response of a particular nozzle and plays a very important role in combustion dynamics, changing the fuel line impedance of one or more nozzle group(s) from one or more other nozzle groups can be used to alter the response of various flame groups to minimize emissions such as, without limitation, NOx, while simultaneously changing flame-acoustic interaction and lowering the combustion dynamics amplitude.

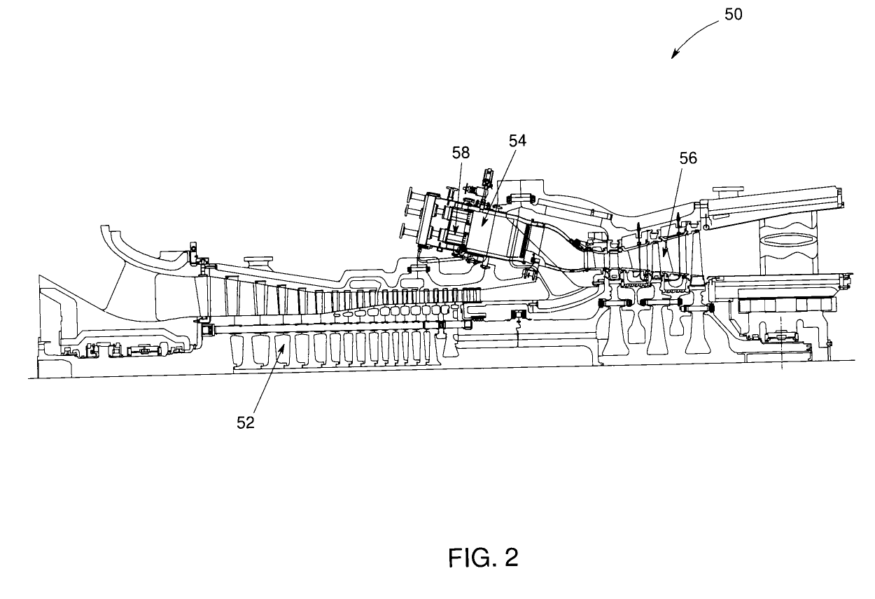

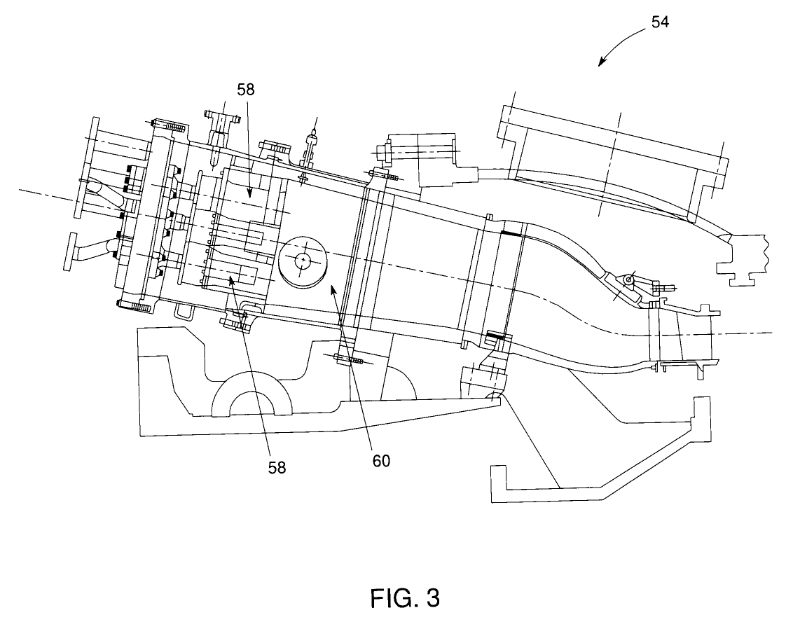

With continued reference to FIG. 1, combustor can 10 may be one member of a multi-can combustor system that can be, for example, a gas turbine such as described below with reference to FIGS. 2 and 3. Combustor can 10 includes a first fuel nozzle group 12, a second fuel nozzle group 20, and a third fuel nozzle group 26. Nozzle group 12 includes nozzles 14, 16, 18. Nozzle group 20 includes nozzles 22, 24. Nozzle group 26 includes single nozzle 28. Each nozzle group 12, 20, 26 receives fuel from a corresponding fuel line 30, 32, 34. Each fuel nozzle comprises a corresponding pre-orifice 36 and a corresponding post-orifice 38. Each fuel nozzle 14, 16, 18, 22, 24, 28 is configured with a desired volume between its corresponding pre-orifice 36 and its corresponding post-orifice 38. Depending on the nozzle design there may be additional geometrical features in the fuel path inside nozzle, which may govern the fuel line impedance.

According to particular embodiments, the fuel line impedance for each nozzle group 12, 20, 26 or a particular fuel nozzle 14, 16, 18, 22, 24, 28 can be varied by changing the size of its corresponding pre-orifice 36, corresponding post-orifice 38, fuel nozzle volume, combinations thereof or by addition of inert species in the fuel line of one of the nozzles. For example, the pre-orifice and post-orifice sizes for fuel nozzle group 12 may be different from the pre-orifice and post-orifice sizes for fuel nozzle group 20. In this manner, the fuel line impedance(s) vary from one nozzle group to another changing the behavior of one flame group from the other. Further depending on additional features inside the nozzle fuel flow passage, a change/alteration in those features can also be used to modify the nozzle fuel line impedance.

The differing fuel line impedance(s) among various nozzle groups may be achieved by fixed geometry variations or may be made variable/adjustable according to the requirements of a particular application, so long as the unwanted emissions are minimized and the combustion dynamics are simultaneously reduced during combustor even fuel split (fuel/air ratio) conditions in accordance with the principles described herein. This variation in fuel impedances among various nozzle groups allows most/all nozzles to operate at similar/identical equivalence ratio, which helps achieve the lowest emission for that gas turbine. Further the variable/adjustable impedance variation features can be used as part of an active or passive control strategy.

In summary, utilizing fuel impedance variations to operate a combustor with a multi-nozzle system at even fuel split conditions results in the least desirable highest combustion dynamics and the most desirable lowest emissions. Systems and methods described herein achieve reduced combustion dynamics below that achievable with combustor systems with similar/identical fuel line impedance, and helps attain the lowest emissions during combustor even fuel split conditions, making even fuel split combustor operation possible, a feature that is not achievable using existing combustor structures and techniques.

FIG. 2 illustrates a gas turbine system 50 that employs the combustor can 10 depicted in FIG. 1. Gas turbine system 50 includes a compressor 52 that supplies compressed air to a combustor 54, and a gas turbine 56 that operates in response to the products of combustion generated via the combustor 54. Fuel nozzles 58 such as nozzles 14, 16, 18, 22, 24, 28 are integrated with combustor 54.

FIG. 3 is a more detailed view of the combustor 54 depicted in FIG. 2. Fuel nozzles 58 are configured to operate as described herein to allow combustor operation at even fuel split conditions with reduced combustion dynamics and minimal emissions. Fuel injected in fuel nozzles 58 mixes with air and combusts in combustion chamber 60. The combustion chamber dynamics are reduced in response to the variances between the individual fuel nozzle impedances while retaining the desired minimal emissions.

According to one embodiment, combustor 54 is a multi-fuel line combustor comprising a plurality of nozzle groups, wherein each nozzle group receives fuel from a corresponding fuel line, and further wherein at least one nozzle group fuel line has an impedance that is different from at least one other nozzle group fuel line impedance. According to another embodiment, a fuel powered machine 50 comprises a can or combustor 54, the can or combustor comprising a multi-fuel line manifold, wherein at least one fuel line has an impedance that is different from at least one other fuel line.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A combustor comprising a plurality of fuel nozzles, wherein at least one nozzle receives fuel from a first fuel line, and further wherein at least one different nozzle receives fuel from a second fuel line, each fuel line having a corresponding impedance such that the first fuel line impedance is fixedly or variably different from the second fuel line impedance.

2. The combustor according to claim 1, wherein the combustor is a gas turbine combustor.

3. The combustor according to claim 1, wherein the combustor is a multi-can combustor.

4. The combustor according to claim 1, wherein the combustor comprises a manifold receiving fuel from a plurality of fuel lines.

5. The combustor according to claim 1, wherein the nozzle fuel line impedances are configured to minimize combustion emissions at a lower level of combustion dynamics during combustor even fuel-split conditions by varying the fuel impedance through geometrical changes or inert addition in various nozzle groups than that achievable during combustor even fuel-split conditions with a multi-fuel line combustor using nozzles with identical or similar impedance and high dynamics preventing attainment of the same low level of combustion emissions.

6. The combustor according to claim 1, wherein the plurality of fuel nozzles comprises at least two groups of fuel nozzles, wherein a first group of fuel nozzles receives fuel from the first fuel line and a second group of fuel nozzles receives fuel from the second fuel line.

7. The combustor according to claim 6, wherein the nozzle fuel line impedances are configured to minimize combustion emissions at a lower level of combustion dynamics during combustor even fuel-split conditions by varying the fuel impedance through geometrical changes or inert addition in various nozzle groups than that achievable during combustor even fuel-split conditions with a multi-fuel line combustor using a fuel line impedance common to all groups of nozzles while emitting substantially the same low level of combustion emissions.

8. A combustor comprising a plurality of fuel nozzles, wherein at least one nozzle receives fuel from a first fuel line, and further wherein at least one different nozzle receives fuel from a second fuel line, each nozzle comprising a fuel line impedance that is fixedly or variably different from at least one other nozzle fuel line impedance.

9. The combustor according to claim 8, wherein the combustor is a gas turbine combustor.

10. The combustor according to claim 8, wherein the combustor is a multi-can combustor.

11. The combustor according to claim 8, wherein the combustor comprises a manifold receiving fuel from a plurality of fuel lines.

12. The combustor according to claim 8, wherein the nozzle fuel splits are configured to minimize combustion emissions at a lower level of combustion dynamics during combustor even fuel-split conditions by varying the fuel impedance through geometrical changes or inert addition in various nozzle groups than that achievable during combustor even fuel-split conditions with a multi-fuel line combustor using nozzles with identical or similar impedance and high dynamics preventing attainment of the same low level of combustion emissions.

13. The combustor according to claim 8, wherein the plurality of fuel nozzles comprises at least two groups of fuel nozzles, wherein a first group of fuel nozzles receives fuel from the first fuel line and a second group of fuel nozzles receives fuel from the second fuel line.

14. The combustor according to claim 13, wherein the nozzle fuel splits are configured to minimize combustion emissions at a lower level of combustion dynamics during combustor even fuel-split conditions by varying the fuel impedance through geometrical changes or inert addition in various nozzle groups than that achievable during combustor even fuel-split conditions with a multi-fuel line combustor using a nozzle fuel impedance common to all groups of nozzles while emitting substantially the same level of combustion emissions.

15. A combustor configured to minimize combustion emissions at a lower level of combustion dynamics during combustor even fuel-split conditions by varying the fuel impedance through geometrical changes or inert addition in various nozzle groups than that achievable during combustor even fuel-split conditions with a multi-fuel nozzle combustor using a nozzle fuel impedance that is common to all nozzles while emitting substantially the same level of combustion emissions.

16. The combustor according to claim 15, wherein the combustor is a gas turbine combustor.

17. The combustor according to claim 15, wherein the combustor is a multi-can combustor.

18. The combustor according to claim 15, wherein the combustor comprises a manifold receiving fuel from a plurality of fuel lines.

19. The combustor according to claim 15, comprising at least two groups of fuel nozzles, wherein a first group of fuel nozzles receives fuel from a first fuel line and a second group of fuel nozzles receives fuel from a second fuel line.

20. The combustor according to claim 19, wherein the first fuel line comprises an impedance that is fixedly or variably different from the impedance of the second fuel line.
